(19) United States
(12) Patent Application Publication
(10) Pub. No.: US 2022/0308592 A1
(43) Pub. Date: Sep. 29, 2022

(54) VISION-BASED OBSTACLE DETECTION FOR AUTONOMOUS MOBILE ROBOTS

(71) Applicant: OhmniLabs, Inc., San Jose, CA (US)

(72) Inventors: Jared GO, Menlo Park, CA (US); Tingxi TAN, Vancouver (CA); Hai DANG, Ho Chi Minh City (VN); Tu PHAN, Ho Chi Minh City (VN)

(73) Assignee: OhmniLabs, Inc., San Jose, CA (US)

(21) Appl. No.: 17/214,364

(22) Filed: Mar. 26, 2021

(51) Int. Cl. G05D 1/02; G05B 13/02; G06K 9/00; G06K 9/40

(52) U.S. Cl. CPC G05D 1/0246; G05B 13/027; G05D 1/0214; G06K 9/00805; G06K 9/40

(57) ABSTRACT

Various aspects related to methods, systems, and computer readable media for vision-based obstacle detection on autonomous mobile robots are described herein. A computer-implemented method can include receiving, from an imaging device of an autonomous mobile robot (AMR), at least one image of a physical environment that includes a floorspace, compressing, at a processor, the at least one image to a fixed image size to obtain an encoded image, providing the encoded image to a trained machine learning model, the trained machine learning model configured to return a pixel classification for each pixel of the encoded image that indicates whether the pixel corresponds to unobstructed floorspace or obstructed floorspace, determining at least a portion of a navigation route based on the pixel classification, and directing the AMR to traverse the portion of the navigation route.

### TECHNICAL FIELD

Embodiments relate generally to mobile robotics, and more particularly, to methods, systems, and computer readable media for vision-based obstacle detection and navigation for autonomous mobile robots.

### BACKGROUND

Mobile robotics platforms include a mobile robot configured to execute commands to navigate a physical environment. Generally, mobile robots require some input, such as environmental input, to determine appropriate parameters for traversing the physical environment. For example, mobile robot navigation systems use computer algorithms (e.g., ranging algorithms) and sensors to gather environmental input. For example, LIDAR devices are optical sensors that measure distances using one or more lasers. Sonar devices are acoustic sensors that measure distances using sound propagation. However, these devices consume significant computing resources, payload capabilities (e.g., due to device weight), and production costs.

Additionally, navigation with ranging techniques lacks semantic insight into the environment. For example, a navigation system using depth sensors, such as LIDAR and SONAR, merely develops a set of data points that are either passable (e.g., no SONAR or LIDAR return) or occupied (e.g., a SONAR ping or LIDAR reflection). Accordingly, while depth and ranging algorithms allow inference of a point or distance to a point, an overall environment cannot be inferred without consuming significant computing resources to repeatedly obtain measurements of a large number of data points representative of an overall environment.

### SUMMARY

Implementations of this application relate to methods, systems, and computer readable media for vision-based obstacle detection on autonomous mobile robots. According to an aspect, a computer-implemented method comprises: receiving, from an imaging device of an autonomous mobile robot, at least one image of a physical environment that includes a floorspace; compressing, at a processor, the at least one image to a fixed image size to obtain an encoded image; providing the encoded image to a trained machine learning model, the trained machine learning model configured to return a pixel classification for each pixel of the encoded image that indicates whether the pixel corresponds to unobstructed floorspace or obstructed floorspace; determining at least a portion of a navigation route based on the pixel classification; and directing the autonomous mobile robot to traverse the portion of the navigation route.

According to some implementations, compressing the at least one image comprises: applying a filter to the at least one image to reduce image noise and obtain a filtered image; and reducing an initial size of the filtered image to the fixed image size.

According to some implementations, the trained machine learning model is a trained neural network configured to classify image pixels as the unobstructed floorspace or the obstructed floorspace.

According to some implementations, the fixed image size corresponds to an image of a fixed width and a fixed height, represented by a rectangular matrix of a predetermined number of pixels.

According to some implementations, the compressing the at least one image is performed by a trained neural network configured to filter noise and to reduce size of the at least one image.

According to some implementations, the determining the portion of the navigation route comprises identifying a destination point on the unobstructed floorspace within the pixel classification; and determining a path to the destination point that excludes the obstructed floorspace.

According to some implementations, the determining the portion of the navigation route further comprises generating a stopping signal based on the pixel classification and based on data from an odometry system of the autonomous mobile robot.

According to another aspect, a computer-implemented method comprises: receiving a first dataset of labeled images of a fixed image size, the labeled images comprising a first layer identifying unobstructed floorspace and a second layer of obstructed floorspace, wherein the labeled images include one or more images captured from a perspective of an autonomous mobile robot; receiving a second dataset of unlabeled images from the autonomous mobile robot; compressing the unlabeled images of the second dataset to the fixed image size; and training a machine learning model to output labels for each image of the second dataset, the labels indicating pixels of the image that correspond to unobstructed floorspace and to obstructed floorspace.

According to some implementations, training the machine learning model is by supervised learning.

According to some implementations, the first dataset of labeled images includes images and corresponding ground truth labels, and wherein the images in the first dataset are used as training images and feedback is provided to the machine learning model based on comparison of the output labels for each training image generated by the machine learning model with ground truth labels in the first dataset.

According to some implementations, the machine learning model includes a neural network and training the machine learning model includes adjusting a weight of one or more nodes of the neural network.

According to some implementations, the machine learning model includes: an encoder that is a pretrained model that generates features based on an input image; and a decoder that takes the generated features as input and generates the labels for the image as output.

According to some implementations, the encoder and the decoder each include a plurality of layers, and wherein features output by each layer in a subset of the plurality of layers of the encoder is provided as input to a corresponding layer of the decoder.

According to some implementations: the plurality of layers of the decoder are arranged in a sequence; the output of each layer of the decoder is upsampled and concatenated with the features output by a corresponding layer of the encoder and provided as input to a next layer in the sequence; and, the output of the final layer of the decoder is a pixel classification for each pixel of the image that indicates whether the pixel corresponds to the unobstructed floorspace or the obstructed floorspace.

According to some implementations, each layer of the decoder performs a deconvolution operation, a batch normalization operation, and a rectified linear unit (ReLU) activation.

According to some implementations, the encoder is a pretrained MobileNetV2 model and wherein the subset of layers includes layers 1, 3, 6, 13, and 16.

According to yet another aspect, an autonomous mobile robot comprises: a camera; a navigation system that includes an actuator; and, a processor coupled to the camera and operable to control the navigation system by performing operations comprising: receiving, from the camera, at least one image of a physical environment that includes a floorspace; compressing, by the processor, the at least one image to a fixed image size to obtain an encoded image; providing the encoded image to a trained machine learning model, the trained machine learning model configured to return a pixel classification for each pixel of the encoded image that indicates whether the pixel corresponds to unobstructed floorspace or obstructed floorspace; determining at least a portion of a navigation route based on the pixel classification; and directing the autonomous mobile robot to traverse the portion of the navigation route.

According to some implementations, compressing the at least one image comprises: applying a filter to the at least one image to reduce image noise and obtain a filtered image; and reducing an initial size of the filtered image to the fixed image size.

According to some implementations, the trained machine learning model is a trained neural network.

According to some implementations, the compressing the at least one image is performed by a trained neural network configured to filter noise and to reduce size of the at least one image.

### BRIEF DESCRIPTION OF THE DRAWINGS

FIG. 1 is a diagram of an example network environment for vision-based obstacle detection and navigation for autonomous mobile robots, in accordance with some implementations.

FIG. 2 is a diagram of an example physical environment for traversal by an autonomous mobile robot, in accordance with some implementations.

FIG. 3 depicts transformation of an input image to a pixel classification, in accordance with some implementations.

FIG. 4 depicts transformation of an input image from a vantage point of an autonomous mobile robot to a pixel classification, in accordance with some implementations.

FIG. 5 is a diagram of transformation of an input image from a vantage point of an autonomous mobile robot to a pixel classification by a machine learning model, in accordance with some implementations.

FIG. 6A is a diagram of an upsampling module, in accordance with some implementations.

FIG. 6B is a table of upsampling parameters and hyperparameters, in accordance with some implementations.

FIG. 7 is a schematic of an example neural network, in accordance with some implementations.

FIG. 8 is a flowchart of an example method of vision-based obstacle detection and navigation, in accordance with some implementations.

FIG. 9 is a flowchart of an example method to train a machine learning model, in accordance with some implementations.

FIG. 10A is a block diagram illustrating an example autonomous mobile robot which may be used to implement one or more features described herein, in accordance with some implementations.

FIG. 10B is a schematic diagram illustrating an example autonomous mobile robot which may be used to implement one or more features described herein, in accordance with some implementations.

FIG. 11 is a block diagram illustrating an example computing device which may be used to implement one or more features described herein, in accordance with some implementations.

### DETAILED DESCRIPTION

One or more implementations described herein relate to vision-based obstacle detection and navigation on autonomous mobile robots. Features can include training of a machine learning model to output a pixel classification of obstructed and unobstructed floorspace, and directing an autonomous mobile robot to traverse unobstructed floorspace detected using the machine learning model.

Generally, an autonomous mobile robot (AMR) is a mobile computing platform that can autonomously traverse a physical area to perform one or more robotic tasks. Some robotic tasks may include telepresence tasks such as attending physical meetings, traversing an office space, or other functions. For example, the AMR can be initiated with a telepresence application and directed to traverse a physical area, allowing interaction between humans and the AMR, as though the AMR physically represents an additional human (e.g., a user's avatar).

While traversing the physical environment, the AMR may utilize onboard resources of the AMR such as: one or more computer processors, memory, storage, battery power, imaging sensors, cameras, and other resources. The AMR may receive data related to the physical environment through a plurality of sensors, such as LIDAR or SONAR sensors. Using received data from the sensors, the AMR may determine a relative distance to an obstruction. For example, the AMR may repeatedly take measurements from a SONAR or LIDAR sensor to determine an approach towards an obstacle. It follows that while SONAR and LIDAR both provide data related to a distance to an obstacle, neither provides an overall understanding of the entire environment or a semantic relationship between traversable and non-traversable areas.

According to aspects of the present disclosure, the AMR may process images received from a camera on-board the AMR to determine a pixel classification of portions of the images that correspond to obstructed and unobstructed floorspace (e.g., traversable and non-traversable areas). The images may be input into a machine learning model that is trained to identify the appropriate pixel classification. Thereafter, a navigation system may identify a dynamic route through the unobstructed floorspace that satisfies other navigation parameters such as: minimum safe distance from obstructed floorspace, time to destination, most efficient route, and/or other considerations or parameters.

It follows that as the AMR may identify a large portion of unobstructed and obstructed floorspace in each image, that the AMR may further identify larger portions of a route that would otherwise be impractical using conventional SONAR and/or LIDAR techniques alone. Additionally, the AMR, using image processing, may identify obstacles that do not adequately reflect SONAR and/or LIDAR (e.g., non-reflective objects, small objects, and other objects). Accordingly, according to aspects of the present disclosure, an AMR may: reduce energy consumption by traversing more efficient routes, reduce energy consumption by relying on a camera instead of multiple sensors (which may be heavy and reduce the carrying capacity of the AMR), reduce maintenance due to reduced travel times, allow more up-time due to efficient energy use, and provide other technical effects and benefits resulting from more efficient navigation.

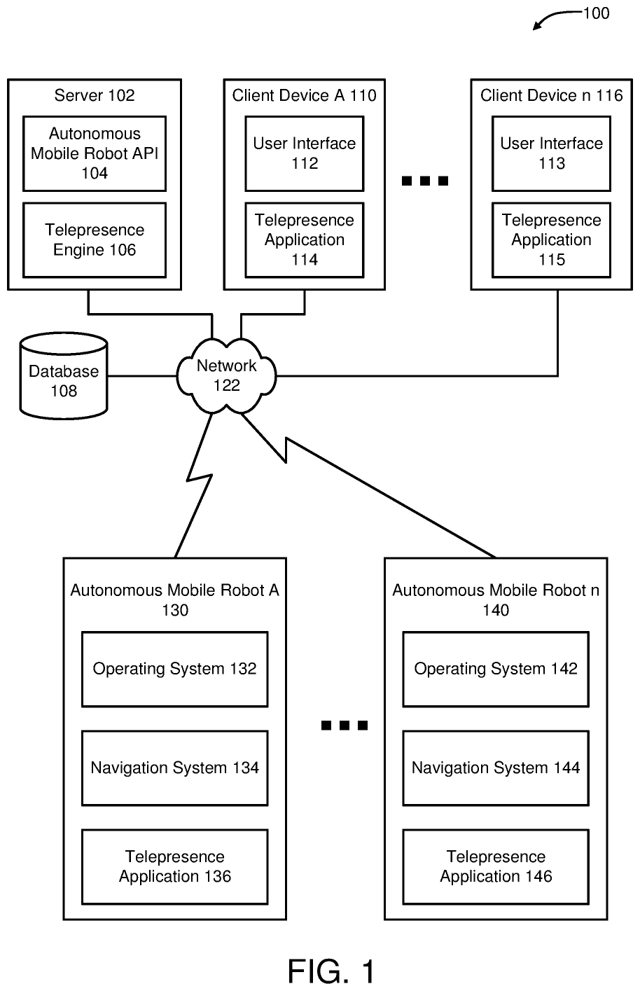

### FIGS. 1 & 2: System Architecture

FIG. 1 illustrates an example network environment 100 for vision-based obstacle detection on autonomous mobile robots, in accordance with some implementations of the disclosure. The network environment 100 (also referred to as “system” herein) includes a server 102, a client device A 110, a client device n 116 (generally referred to as “client devices” 110/116), an AMR A 130, an AMR n 140 (generally referred to as “AMRs” herein), and a data store 108, all coupled via a network 122. The server 102 can include, among other things, an AMR application programming interface (API) 104, and a telepresence engine 106. The client devices 110/116 can include a user interface 112/113 and a telepresence application 114/115. A user may interact with the client device 110/116, through the interfaces 112/113, to operate a telepresence routine on the AMRs 130/140.

Network environment 100 is provided for illustration. In some implementations, the network environment 100 may include the same, fewer, more, or different elements configured in the same or different manner as that shown in FIG. 1.

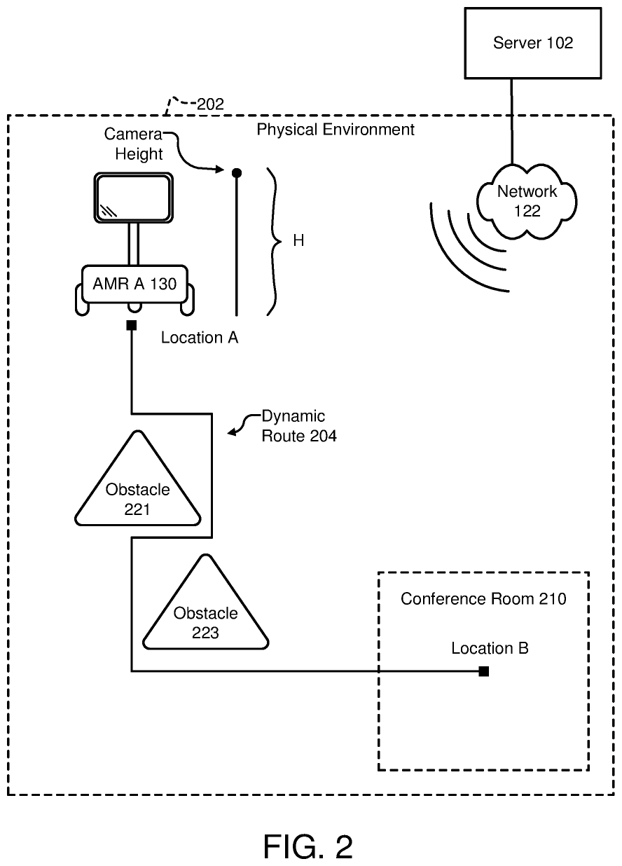

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof. According to some implementations, the network 122 is a private network that allows wired and wireless communications in a physical environment (illustrated in FIG. 2).

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the server 102 and to provide a user with access to server 102. The server 102 may also include a website (e.g., one or more webpages) or application back-end software that may be used to provide a user with access to content provided by server 102. For example, users may access server 102 using the user interface 112/113.

In some implementations, server 102 may expose the AMR API 104 to users of client devices (e.g., client device 110/116) such that program functions, calls, and other features may be used to interact with AMRs 130/140. Users may also interact with a telepresence application 114/115 on a respective client device 110/116. As used herein, a telepresence application is a software application that allows for communication (e.g., video and/or audio communication) from a client device 110/116 and a telepresence application 136/146 onboard an AMR 130/140. The telepresence application may, for example, display a video conference call from a user at client device 110 on the AMR 130 (e.g., on a display device). In this regard, the AMR 130 may represent a physical avatar of a user that is able to traverse a physical space and interact with the physical space while being remote (e.g., remote conferencing, telework, etc.).

In some implementations, each AMR may include an operating system 132, 142, a navigation system 134, 144, and a telepresence application 136, 146, as described above. Generally, the operating system 132, 142 may be an operating system including all suitable software components to enable initialization and use of the AMR. Additionally, the navigation system 134, 144 may be a software system configured to aid and direct the AMR to navigate a physical environment through obstacle avoidance, mapping, route planning, sensor data, and other aspects. Therefore, each AMR is “autonomous” and can navigate physical environments to arrive at one or more destinations to perform one or more robotic tasks, including display of a telepresence interface on a display apparatus of the AMR.

In general, functions described as being performed by the server 102 can also be performed by the client devices 110/116, in other implementations if appropriate. In addition, the functionality attributed to a particular component can be performed by different or multiple components operating together. The server 102 can also be accessed as a service provided to other systems or devices through appropriate application programming interfaces (APIs), and thus is not limited to use with the particular components illustrated.

In some implementations, server 102 may include a respective navigation system and/or operating system somewhat similar to those of each AMR (e.g., 132, 134, 142, 144). As such, the server 102 may perform functions as though from the perspective of the AMR, including interpreting sensor data, image data, task data, navigation data, obstacle avoidance data, and other similar data.

Hereinafter, operation of an autonomous mobile robot is described more fully with reference to FIG. 2.

FIG. 2 is a diagram of an example physical environment 202 in which robotic tasks may be performed by an AMR, in accordance with some implementations. Generally, it should be understood that the AMR 130 may be equipped with any feature disclosed herein, and may be initialized to execute the telepresence application 136, in the illustrated example.

As illustrated, AMR 130 may have a camera height H and may be directed to a physical location 210 (e.g., a conference room) by a user of the telepresence application 114. For example, a user, manipulating the user interface 112 and/or telepresence application 114, may direct the AMR 130 to establish a dynamic route 204 from Location A to Location B (e.g., located within conference room 210). The AMR 130, using an on-board camera, may receive image data (e.g., a plurality of images, a single image, and/or a video stream) representative of the physical environment 202.

The received images may include portions that correspond to the obstacle 221 and/or obstacle 223. Using a machine learning model, the received images may by initially encoded, the encoded images may be subsequently decoded, and a pixel classification for each pixel of each decoded image may be output by the machine learning model. The pixel classification may indicate whether the pixel corresponds to unobstructed floorspace or obstructed floorspace.

Using the pixel classification for each pixel, the navigation system 134 may calculate the dynamic route 204 that accomplishes at least one or more of: traversing the physical environment 202 while avoiding obstacle 221 and obstacle 223; traversing from Location A to Location B; entering physical space/conference room 210; and, avoiding any new obstacles (e.g., other AMRs, people, pets, other moving objects, other objects added to the environment, etc.) detected via image processing during traversal and operation within physical environment 202.

While traversing and interacting with the physical environment 202, the AMR 130 may continually or intermittently display graphical elements on a respective display screen representative of the telepresence application 114. In this regard, an avatar or image representation of the user may be displayed, a live video feed of the user's face may be displayed, and furthermore, camera views from the AMR 130 may also be transmitted back to the user of client device 110. Thus, the user may be entirely remote from the physical environment 202 while still having a physical representation (i.e., the AMR 130) present within the physical environment 202. It is noted that these examples are illustrative only, and are non-limiting.

It is noted that the AMR 130 may be in communication with the server 102 while in the process of performing any tasks. As such, other applications, routines, and methodologies may also be implemented by the server 102. For example, the server 102 may direct the AMR 130 to traverse the physical environment 202 through automated instructions. In this manner, even if the telepresence application 114 has been terminated by a user, the server 102 may direct the AMR 130 to traverse the physical environment 202 to: move to a next scheduled conference room or location, return to a “home base” for charging/maintenance functions, and other tasks. The server 103 may also direct multiple AMRs to traverse the physical environment 202, relatively simultaneously, and may dispatch telepresence connections to any single AMR based on a plurality of features such as: closest to Location B/destination, battery charge level, onboard resources (e.g., different capabilities based on user requirements), functional status (e.g., stalled/stuck), or other parameters.

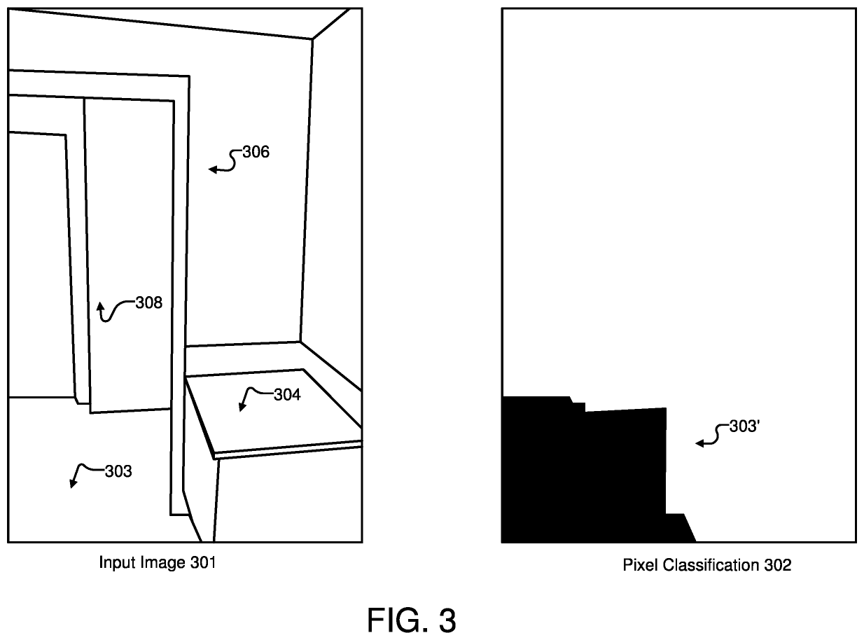

### FIGS. 3-7: Image Processing and Pixel Classifications

FIG. 3 depicts transformation of an input image 301 to a pixel classification 302, in accordance with some implementations. As shown, input image 301 may be received from a camera, such as a forward facing camera on a tablet computer or other device. The image 301 may include any level of detail, with discernable features such as: table 304, main floor 303, doorway 306, and wall 308. Other features may also be apparent.

When considering the content of the image 301, it is readily apparent that main floor 303 may be the most appropriate for traversal of an AMR, such as AMR 130. For example, the AMR 130 may readily traverse the floor 303 with sufficient room for avoiding obstacles 304 and 308. Thus, the image 301 may be analyzed, using a machine learning model, to classify pixels therein to indicate the presence or absence of floorspace.

For example, pixel classification 302 may represent all data of input image 301, with a representation of unobstructed floorspace 303′ being one value (unobstructed floorspace), and all other obstructions being a second value (e.g., whitespace). Thus, an AMR may use the data of the pixel classification 302 to establish as least a portion of a dynamic route, for example, through doorway 306. This portion of the dynamic route may be calculated relatively quickly, and may not need to rely on SONAR and/or LIDAR unless desired. Thus, an AMR according to the aspects disclosed herein may relatively quickly determine an appropriate route with on-board camera input.

As briefly noted with reference to FIG. 2, an AMR may have a camera height H associated therewith. The camera height may be based on a support structure of an AMR extending vertically to support a display apparatus (e.g., a tablet computer or display monitor) above at a reasonable height for interacting in a telepresence situation. Accordingly, while the input image 301 is shown as being taken from a height, e.g., of a person holding a camera in their hand, an image from a perspective or vantage point of the AMR 130 may be different.

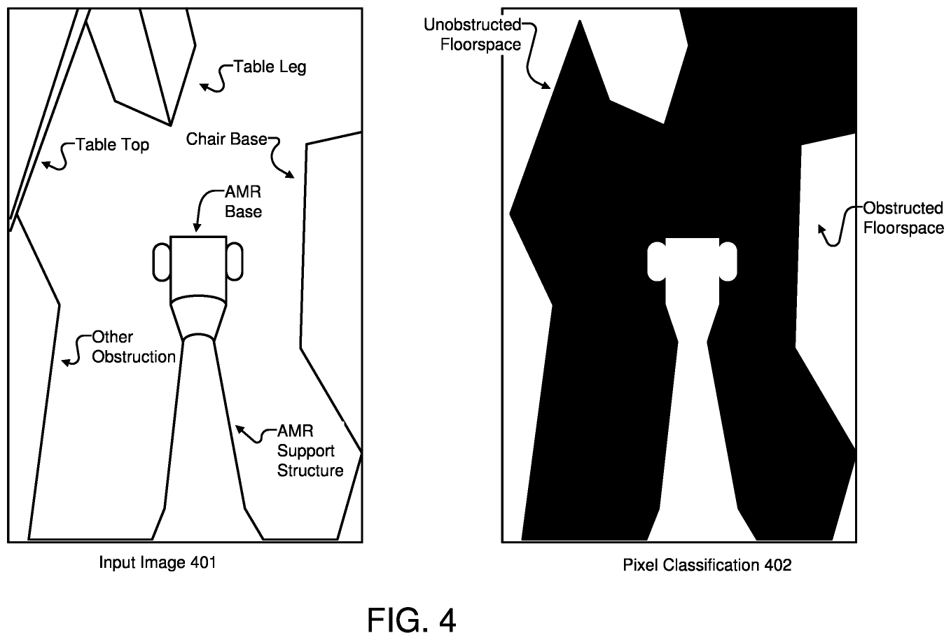

FIG. 4 depicts transformation of an input image 401 from a vantage point of an autonomous mobile robot to a pixel classification 402, in accordance with some implementations. As shown, input image 401 may be received from a camera mounted on an autonomous mobile robot. The image 401 may include any level of detail, with discernable features such as: table tops, table legs, chairs, and other obstructions. Furthermore, as the image 401 is from a vantage point of the AMR 130, the AMR base and/or support structure may also be partially visible. Other features may also be apparent.

The image 401 may be analyzed, using a machine learning model, to classify pixels therein to indicate the presence or absence of unobstructed floorspace. For example, pixel classification 402 may represent all data of input image 401, with a representation of unobstructed floorspace being one value, and all other obstructions being a second value (e.g., floorspace that is obstructed due to the presence of an object).

An AMR may use the data of the pixel classification 402 to establish as least a portion of a dynamic route, for example, over the unobstructed floorspace between a table leg and chair base, while also monitoring the location of its base and support structure. This portion of the dynamic route may be calculated relatively quickly, and may not need to rely on SONAR and/or LIDAR. Thus, an AMR according to the aspects disclosed herein may relatively quickly determine an appropriate route with camera input from its vantage point or perspective, while also taking into account its physical dimensions (e.g., the AMR base) as captured within the same on-board camera input. In this manner, physical sensors such as: resistive bumpers, safety strips, redundant SONAR, redundant LIDAR, and similar components, may be omitted if desired without affecting the performance of the AMR.

Generally, the transformation from the input images 301, 401 to pixel classifications 302, 402, may be implemented using an encoder and decoder based on a machine learning model, as described below.

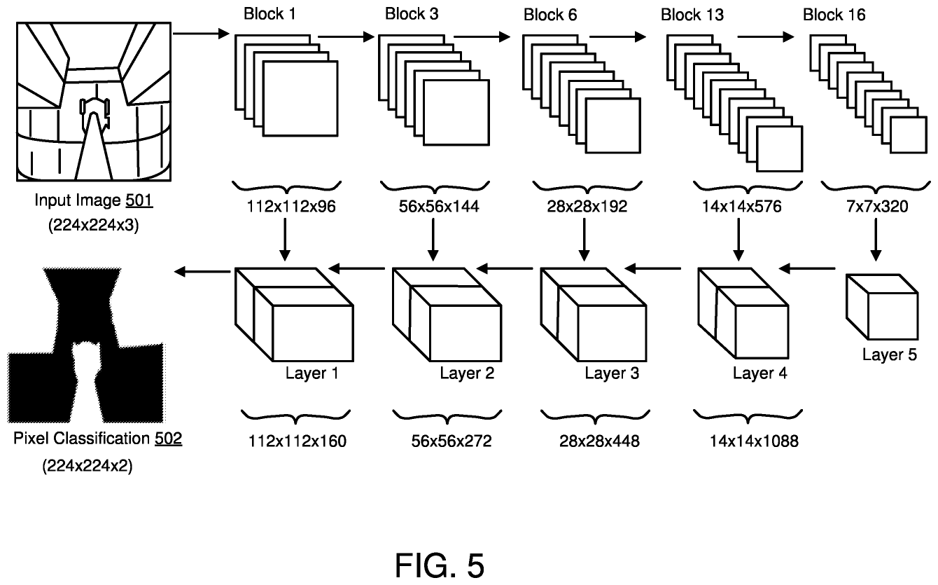

FIG. 5 is a diagram of transformation of an input image 501 from a vantage point of an autonomous mobile robot to a pixel classification 502 by a machine learning model, in accordance with some implementations. As illustrated, encoder operations encompass the upper portion of FIG. 5 while decoder operations encompass the lower portion of FIG. 5. The encoder and decoder operations are sequential, in this example.

As show, the encoder and the decoder each include a plurality of layers (blocks). Features output by each layer, in a subset of the plurality of layers of the encoder, is provided as input to a corresponding layer of the decoder, on the lower portion of FIG. 5. The plurality of layers of the decoder are arranged in a sequence, with the output of each layer of the decoder upsampled and concatenated with the features output by a corresponding layer of the encoder and provided as input to a next layer in the sequence.

The output of the final layer is the pixel classification 502 for each pixel of the input image 501. The pixel classification indicates whether each pixel in an image corresponds to unobstructed floorspace or obstructed floorspace. The pixel classification may be considered a two-channel image. Furthermore, according to one implementation, both the input image 501 and the pixel classification 502 are of a fixed height and width (and therefore a fixed number of pixels). However, variances in height and width may be applicable to other implementations.

As further shown in FIG. 5, each layer of the decoder (e.g., the bottom portion of FIG. 5) performs a deconvolution operation, a batch normalization operation, and a rectified linear unit (ReLU) activation. The decoder and encoder may each be a machine learning model based on a neural net, e.g., a U-net-like neural network. In some implementations, the encoder may be a pretrained MobileNetV2 model. Finally, as further illustrated, in some implementations, a subset of layers of the encoder that are configured to provide their output to a corresponding layer of the decoder may include layers 1, 3, 6, 13, and 16. In different implementations, more or fewer layers or a different subset of layers of the encoder may be configured to provide their output to the decoder. In some implementations, each layer of the encoder and/or decoder may include one or more nodes that perform a particular type of computation.

As seen in FIG. 5, the input image is of 224×224 pixels (height and width), with each pixel having 3 additional values, e.g., in red-green-blue (RGB) colorspace, YuV colorspace, etc. As the image is analyzed by the encoder, encoded representations of the image having different numbers of dimensions are produced at each layer of the encoder, e.g., 112×112×96 at block 1, 56×56×144 at block 3, and on, as illustrated in FIG. 5. Similarly, the different decoder layers may produce representations of different dimensions. As seen in FIG. 5, the output pixel classification 502 of the decoder has the same dimensions (224×224) as the input image in two-channels (224×224×2).

Accordingly, the output image or pixel classification has 2 channels (224×224×2) in shape. The value of each entry in the pixel classification represents the confidence said entry represents obstructed and unobstructed floorspace. For example, the 2-channels may be represented as a range of [0, 1]. The first channel represents confidence values of obstructed floorspace. The second channel represents confidence values of unobstructed floorspace. Upon generation of the output image or pixel classification, confidence values are compared between the two channels for each pixel. Thus, the final output pixel classification is determined by the maximum confidence of either obstructed or unobstructed floorspace (e.g., a pixel with the greater confidence value between the two channels is selected as the final classification value). As a result, the final pixel classification 502 (224×224×2) is an image where the value of each pixel now represents its labels, wherein zero is obstructed and one is unobstructed floorspace.

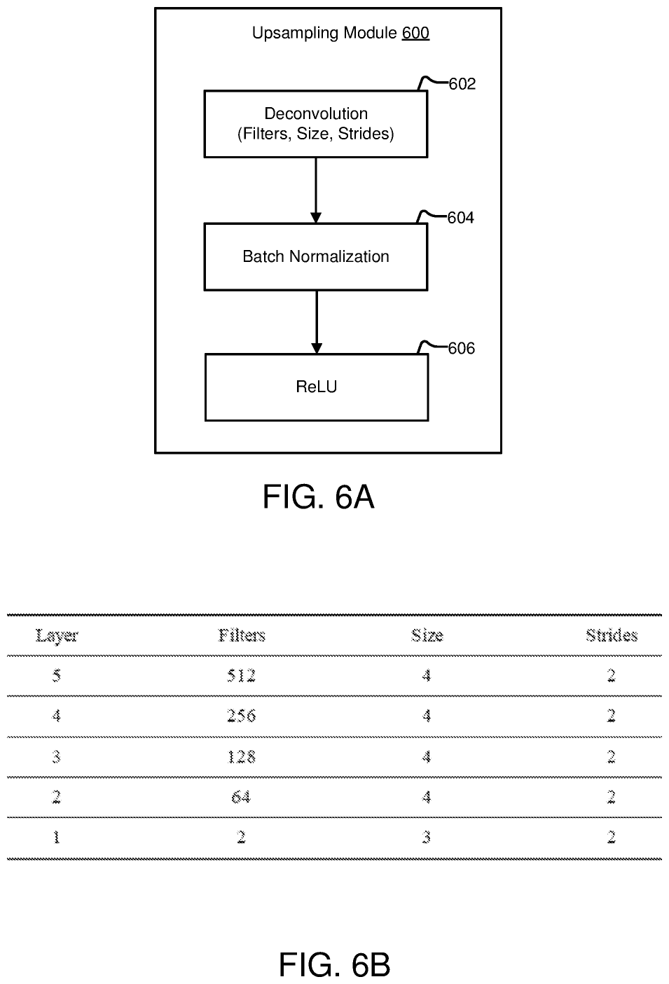

FIG. 6A is a diagram of an upsampling module 600 of a decoder machine learning model, in accordance with some implementations. As shown, the upsampling module 600 may include a deconvolution component 602, a batch normalization component 604, and a rectified linear unit component 606. The deconvolution component 602 may utilize a predetermined number of filters, sizes, and strides to perform deconvolution of an input image. The batch normalization component 604 may normalize the deconvoluted images, and the normalized images may be input into the ReLU component 606 for activation.

FIG. 6B is a table of upsampling parameters and hyperparameters, in accordance with some implementations. As shown, the deconvolution component 602 may operate with the predetermined or desired filter, size, and stride parameters as specified in the table. However, it is noted that the particular values indicated are for illustrative purposes only, and are non-limiting of every implementation.

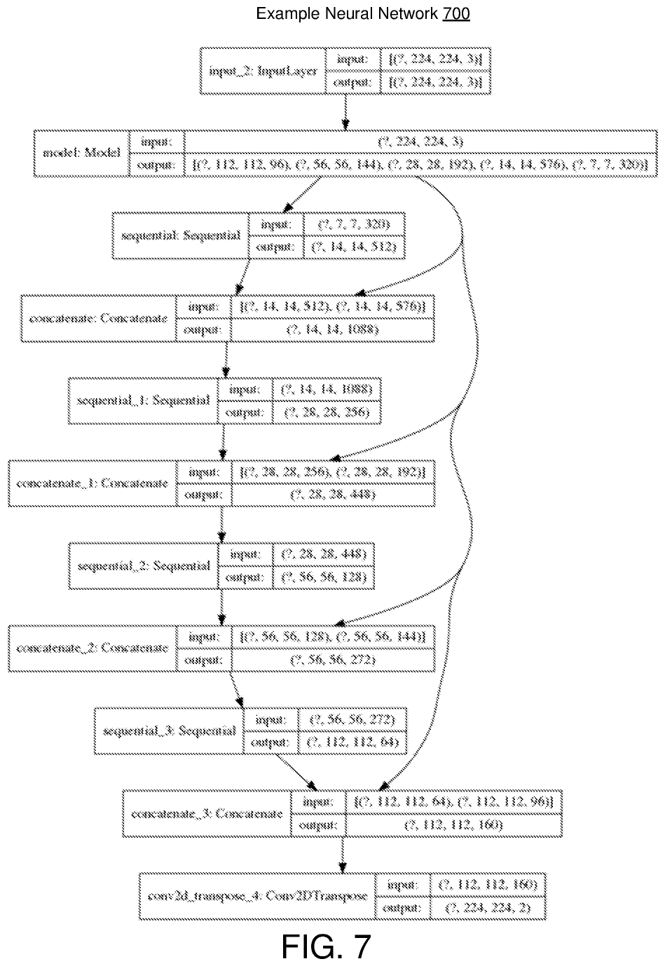

FIG. 7 is a schematic of an example neural network 700, in accordance with some implementations. The network 700 is a logical representation of the sequential operations illustrated and described with reference to FIG. 5. For example, the encoder and the decoder each include a plurality of layers. Features output by each layer, in a subset of the plurality of layers of the encoder, is provided as input to a corresponding layer of the decoder. The plurality of layers of the decoder are arranged in sequence, with the output of each layer of the decoder upsampled and concatenated with the features output by a layer of the encoder and provided as input to a next layer in the sequence.

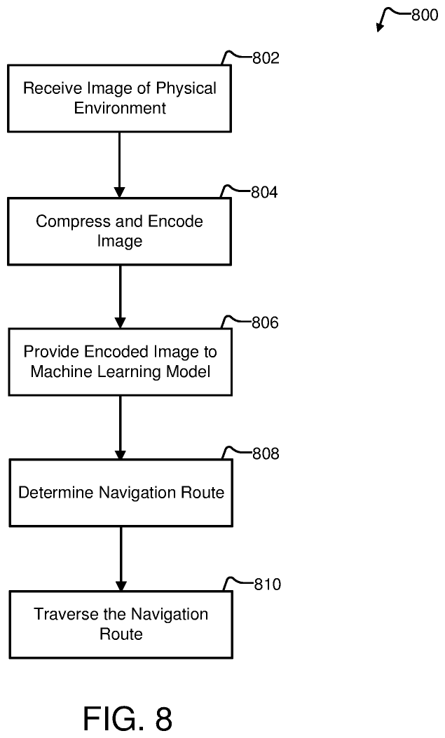

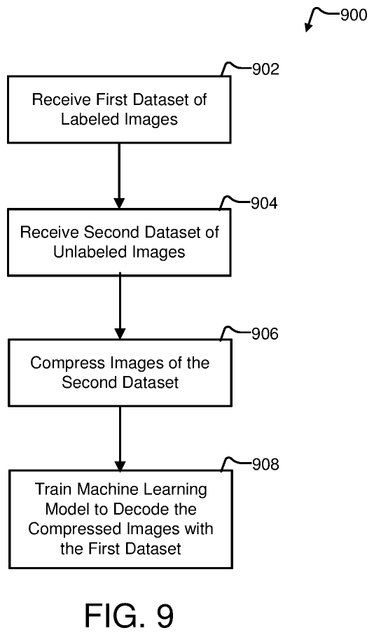

After processing, the pixel classification may be used to calculate a route. For example, the route may be calculated such that the AMR traverses unobstructed floorspace while avoiding obstructed floorspace. Furthermore, images from a vantage point or perspective of the AMR may be used in training the neural network. In this manner, a body of the AMR and/or other features such as support structures or overhangs are also represented in the processed images as obstructed floorspace. Thus, simplified route planning calculations may be possible whereby the physical dimensions of the AMR are already taken into account, thereby simplifying obstacle avoidance further. Hereinafter, methodologies for the operation of AMRs with machine learning models and training of the machine learning models are described in detail with reference to FIGS. 8-9.

### FIG. 8: Vision-Based Obstacle Detection for an AMR

FIG. 8 is a flowchart of an example method 800 of vision-based obstacle detection and navigation for autonomous mobile robots, in accordance with some implementations. The method 800 begins at block 802.

At block 802, at least one image of a physical environment 202 that includes a floorspace 303, is received from an imaging device (e.g., a camera) of an AMR. The camera may be a forward-mounted camera or another camera otherwise affixed to, or part of, the AMR. In some implementations, if a laptop computer or tablet computer is mounted on a telepresence AMR, a camera device from the laptop or tablet may be used to take navigation images. In some implementations, a discrete camera may be mounted and/or affixed to any portion of the AMR to take navigation images. Still further, in some implementations, a specialized camera (e.g., navigation-specific) with predetermined lensing (e.g., wide angle, ultra-wide angle, fish-eye, etc.) may be used to take navigation images. Block 802 is followed by block 804.

At block 804, the at least one image is compressed or encoded to a fixed image size to obtain an encoded image. An example of such an image is the image 401 of FIG. 4. The image may be encoded through an encoder sequence as illustrated in FIG. 5. Block 804 is followed by block 806.

At block 806, the encoded image is provided to a trained machine learning model. The trained machine learning model may be configured to return the pixel classification for each pixel of the encoded image that indicates whether the pixel corresponds to at least one of unobstructed floorspace and obstructed floorspace. For example, the image after encoding, may be input into a neural network (e.g., network 700, or other neural network), where a sequence of operations is performed to upsample and concatenate individual layers to generate the pixel representation (e.g., pixel representation 402 of FIG. 4). Block 806 is followed by block 808.

At block 808, at least a portion of a navigation route is determined based on the pixel classification. The portion of the navigation route may be calculated and/or determined by a navigation system 134/144 of the AMR. The portion of the navigation route may be based on any suitable route-planning algorithm, and may include a plurality of considerations including overall travel time, distance to destination, battery charge levels, and other factors. The route may be determined to avoid obstructed floorspace.

Additionally, in some implementations, determining the portion of the navigation route may be supplemented by an onboard odometry system of the AMR. For example, the portion of the navigation route may be calculated by: identifying a destination point on the unobstructed floorspace within the pixel classification, determining a path to the destination point that excludes the obstructed floorspace, and generating a stopping signal based on the pixel classification and based on data from an odometry system of the AMR. In this manner, the stopping signal may direct the AMR to physically stop, and process additional data (e.g., additional images), until an obstruction (e.g., another AMR that enters a position on the route) moves away from the route or a different path is calculated. Other route planning and navigation considerations may also be implemented. Block 808 is followed by block 810.

At block 810, the AMR is directed to traverse the portion of the navigation route. In this example, the AMR may move forward, move backwards, or a combination of forwards/backwards with turns, to navigate the calculated portion of the dynamic path 204. While maneuvering, it should be understood that blocks 802-810 may be repeated as necessary (e.g., in real-time) such that the AMR detects and avoids new obstacles in a physical environment.

As explained above, the AMR may receive and process images from a camera or imaging device, such as a camera affixed to the AMR, affixed to a display device, or a tablet computer with integrated camera mounted on the AMR. The images may be from a vantage point at height H above the floor, e.g., the height of the position on the AMR at which the camera is mounted. Accordingly, in some implementations, the machine learning model may be trained using images captured by a camera mounted at the same or similar height, with pre-labeling of obstructed/unobstructed floorspace that can be used to train the machine learning model using supervised learning.

### FIG. 9: Training Machine Learning Model of an AMR

FIG. 9 is a flowchart of an example method 900 of training a machine learning model, in accordance with some implementations. The method 900 may begin at block 902.

At block 902, a first dataset of labeled images of a fixed image size is received. The labeled images can include a first layer identifying unobstructed floorspace and a second layer of obstructed floorspace, the labeled images being from a perspective of the AMR or from a camera at the approximate height H. This first dataset may be manually labeled and or otherwise examined to establish accuracy of labeling. Block 902 is followed by block 904.

At block 904, a second dataset of unlabeled images is received from the AMR. The second dataset may be an unlabeled training dataset, or may be a real-time dataset from a functioning AMR. The second dataset may be used to judge performance and fine-tune the AMR and/or machine learning model. Block 904 is followed by block 906.

At block 906, the unlabeled images of the second dataset are compressed/encoded to the fixed image size. For example, as illustrated in FIG. 5, the second dataset may be downsampled, layer by layer, in sequence. Block 906 is followed by block 908.

At block 908, the machine learning model is trained to decode the compressed unlabeled images using the first dataset. The machine learning model may utilize a neural network, e.g., network 700 or other neural network, or another type of model. The machine learning model is trained to output labels for each image of the second dataset. The output labels indicate pixels of the image that correspond to unobstructed floorspace and to obstructed floorspace. Thus, the AMR may use the labeled data for navigation, or the newly labeled data may be used in further training and enhancements of the machine learning model.

As described above, an AMR may receive a plurality of images from a camera, encode and downsample the images, decode and upsample the images to create a pixel classification, and use the pixel classification to plan a route for traversal. The pixel classification is a representation of each pixel of the image that indicates whether a pixel corresponds to unobstructed or obstructed floorspace. Furthermore, as a body or portion of a main body of the AMR may be visible in the processed images, the physical dimensions of the AMR are already taken into account during image processing such that route planning may be simplified.

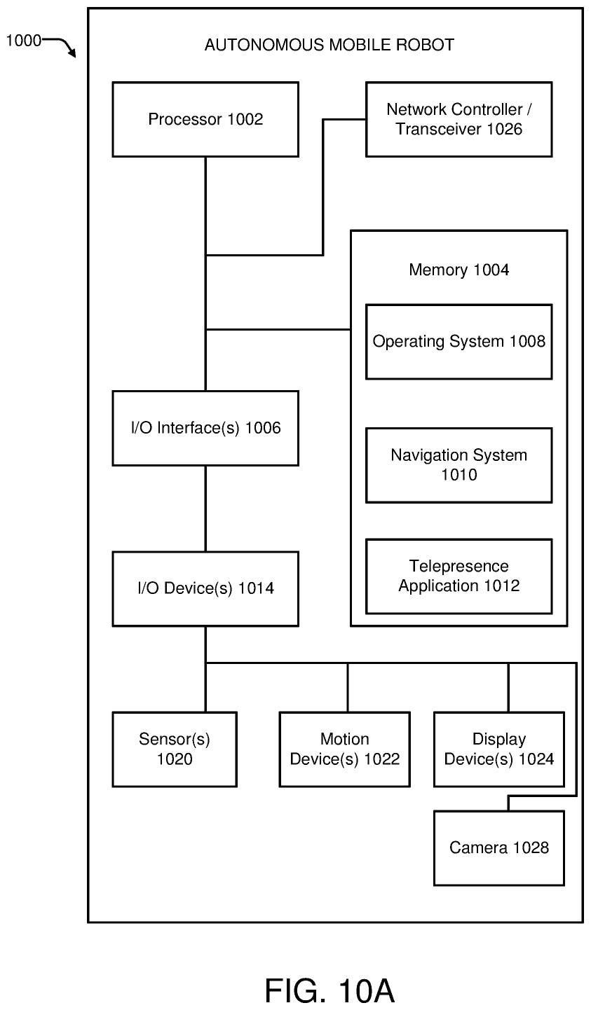

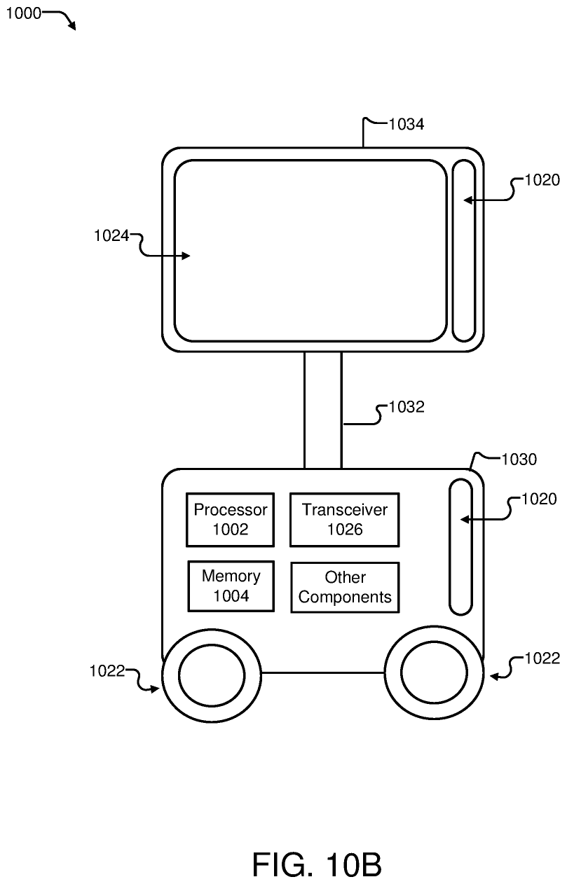

Hereinafter, a more detailed description of autonomous mobile robots that may be used to implement features illustrated in FIGS. 1-9 is provided with reference to FIGS. 10A and 10B.

FIG. 10A is a block diagram of an example autonomous mobile robot (AMR) 1000, and FIG. 10B is a schematic of the AMR 1000, which may be used to implement one or more features described herein. AMR 1000 can be any suitable robotic system, autonomous mobile server, or other robotic device such as, for example, an autonomous telepresence robot. In some implementations, AMR 1000 includes a processor 1002, a memory 1004, input/output (I/O) interface 1006, I/O devices 1014, and network device/transceiver 826.

Processor 1002 can be one or more processors and/or processing circuits to execute program code and control basic operations of the AMR 1000. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. A processor may perform its functions in “real-time,” “offline,” in a “batch mode,” etc. Portions of processing may be performed at different times and at different locations, by different (or the same) processing systems. A computer may be any processor in communication with a memory.

Memory 1004 is typically provided in AMR 1000 for access by the processor 1002, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1002 and/or integrated therewith. Memory 1004 can store software operating on the AMR 1000 by the processor 1002, including an operating system 1008, a navigation system 1010, and a telepresence application 1012.

Memory 1004 can include software instructions for the telepresence application 1012, as described with reference to FIG. 1. Any of software in memory 1004 can alternatively be stored on any other suitable storage location or computer-readable medium. In addition, memory 1004 (and/or other connected storage device(s)) can store instructions and data used in the features described herein. Memory 1004 and any other type of storage (magnetic disk, optical disk, magnetic tape, or other tangible media) can be considered “storage” or “storage devices.”

I/O interface 1006 can provide functions to enable interfacing the AMR 1000 with other systems and devices. For example, network communication devices, storage devices (e.g., memory and/or data store 108), and input/output devices can communicate via interface 1006. In some implementations, the I/O interface can connect to devices 1014 including one or more of: sensor(s) 1020, motion device(s) 1022 (e.g., motors, wheels, tracks, etc.), display device(s) 1024 (e.g., a mounted tablet, phone, display, etc.), and camera(s) 1028.

For ease of illustration, FIG. 10A shows one block for each of processor 1002, memory 1004, I/O interface 1006, software blocks 1008-1012, and devices 1020-1028. These blocks may represent one or more processors or processing circuitries, operating systems, memories, I/O interfaces, applications, and/or software modules. In other implementations, AMR 1000 may not have all of the components shown and/or may have other elements including other types of elements instead of, or in addition to, those shown herein.

Turning to FIG. 10B, a schematic of the AMR 1000 is provided. As shown, the AMR includes a main body 1030, a support structure 1032 attached to the main body 1030, and a display structure 1034 attached to the support structure 1032. The support structure may be a telescoping structure configured to raise/lower the display structure 1034 to differing heights H above the main body 1030 and/or floor level.

Generally, the main body 1030 may house and protect the components illustrated, such as the processor 1002, memory 1004, network device/transceiver 1026, and/or other devices. Furthermore, sensor devices and other I/O devices 1020 may be distributed on the main body 1030, support structure 1032, and/or display structure 1034. Additionally, wheels may be included as an implementation of the motion devices 1022, although other motion devices such as: actuators, solenoids, end-of-arm tooling, telescoping apparatuses, tracks, treads, and other devices may also be applicable.

The AMR 1000 may be fully or partially autonomous, and may navigate routes in a physical space or area based on instructions processed at processor 1002. The AMR 1000 may also implement a telepresence application 1012 such that a user may interact with a physical environment remotely (e.g., using the transceiver 826), with a trained machine learning model providing pixel classifications to a navigation system to handle route-planning during the telepresence session.

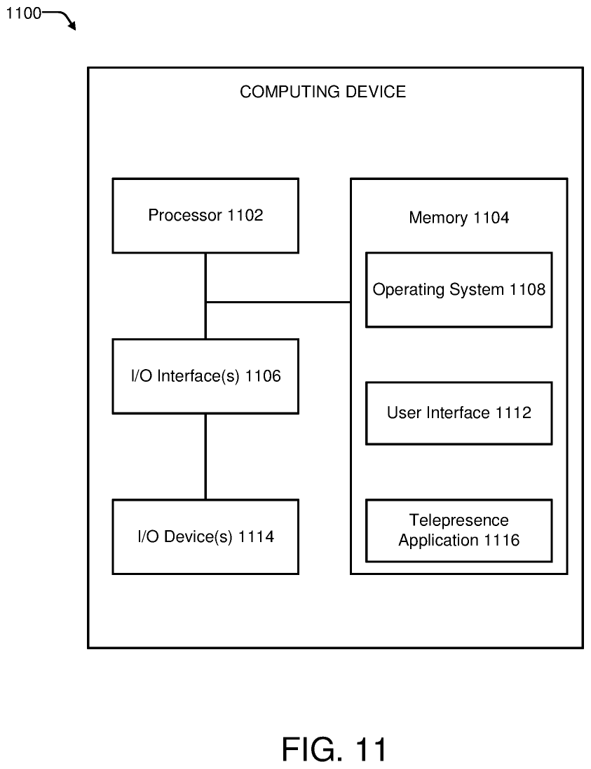

Hereinafter, a more detailed description of various computing devices that may be used to implement different devices (e.g., the server 102 and/or client device(s) 110/116) illustrated in FIG. 1, is provided with reference to FIG. 11.

FIG. 11 is a block diagram of an example computing device 1100 which may be used to implement one or more features described herein, in accordance with some implementations. In one example, device 1100 may be used to implement a computer device, (e.g., 110/116 of FIG. 1), and perform appropriate method implementations described herein. Computing device 1100 can be any suitable computer system, server, or other electronic or hardware device. For example, the computing device 1100 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1100 includes a processor 1102, a memory 1104, input/output (I/O) interface 1106, and audio/video input/output devices 1114 (e.g., display screen, touchscreen, display goggles or glasses, audio speakers, microphone, etc.).

Processor 1102 can be one or more processors and/or processing circuits to execute program code and control basic operations of the device 1100. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1104 is typically provided in device 1100 for access by the processor 1102, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1102 and/or integrated therewith. Memory 1104 can store software operating on the server device 1100 by the processor 1102, including an operating system 1108, a user interface 1112, and a telepresence application 1116.

Memory 1104 can also include software instructions for a robotic programming interface to manipulate an AMR, as described with reference to FIG. 1. Any of software in memory 1104 can alternatively be stored on any other suitable storage location or computer-readable medium. In addition, memory 1104 (and/or other connected storage device(s)) can store instructions and data used in the features described herein. Memory 1104 and any other type of storage (magnetic disk, optical disk, magnetic tape, or other tangible media) can be considered “storage” or “storage devices.”

I/O interface 1106 can provide functions to enable interfacing the server device 1100 with other systems and devices. For example, network communication devices, storage devices (e.g., memory and/or data store 116), and input/output devices can communicate via interface 1106. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 11 shows one block for each of processor 1102, memory 1104, I/O interface 1106, and software blocks 1108-1116. These blocks may represent one or more processors or processing circuitries, operating systems, memories, I/O interfaces, applications, and/or software modules. In other implementations, device 1100 may not have all of the components shown and/or may have other elements including other types of elements instead of, or in addition to, those shown herein. While the server 102 is described as performing operations as described in some implementations herein, any suitable component or combination of components of server 102 or similar system, or any suitable processor or processors associated with such a system, may perform the operations described.

A user device can also implement and/or be used with features described herein. Example user devices can be computer devices including some similar components as the device 1100, e.g., processor(s) 1102, memory 1104, and I/O interface 1106. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1114, for example, can be connected to (or included in) the device 1100 to display images, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices, servers, and autonomous mobile robots (AMRs). In some implementations, one or more methods described herein can be implemented, for example, on a server system with a dedicated AMR, and/or on both a server system and any number of AMRs. In some implementations, different components of one or more servers and/or AMRs can perform different blocks, operations, or other parts of the methods.

One or more methods described herein (e.g., methods 800 and/or 900) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
receiving, from an imaging device of an autonomous mobile robot, at least one image of a physical environment that includes a floorspace;
compressing, at a processor, the at least one image to a fixed image size to obtain an encoded image;
providing the encoded image to a trained machine learning model, the trained machine learning model configured to return a pixel classification for each pixel of the encoded image that indicates whether the pixel corresponds to unobstructed floorspace or obstructed floorspace;
determining at least a portion of a navigation route based on the pixel classification; and
directing the autonomous mobile robot to traverse the portion of the navigation route.

2. The computer-implemented method of claim 1, wherein compressing the at least one image comprises:
applying a filter to the at least one image to reduce image noise and obtain a filtered image; and
reducing an initial size of the filtered image to the fixed image size.

3. The computer-implemented method of claim 1, wherein the trained machine learning model is a trained neural network configured to classify image pixels as the unobstructed floorspace or the obstructed floorspace.

4. The computer-implemented method of claim 3, wherein the fixed image size corresponds to an image of a fixed width and a fixed height, represented by a rectangular matrix of a predetermined number of pixels.

5. The computer-implemented method of claim 1, wherein the compressing the at least one image is performed by a trained neural network configured to filter noise and to reduce size of the at least one image.

6. The computer-implemented method of claim 1, wherein the determining the portion of the navigation route comprises:
identifying a destination point on the unobstructed floorspace within the pixel classification; and
determining a path to the destination point that excludes the obstructed floorspace.

7. The computer-implemented method of claim 6, wherein the determining the portion of the navigation route further comprises generating a stopping signal based on the pixel classification and based on data from an odometry system of the autonomous mobile robot.

8. A computer-implemented method, comprising:
receiving a first dataset of labeled images of a fixed image size, the labeled images comprising a first layer identifying unobstructed floorspace and a second layer of obstructed floorspace, wherein the labeled images include one or more images captured from a perspective of an autonomous mobile robot;
receiving a second dataset of unlabeled images from the autonomous mobile robot;
compressing the unlabeled images of the second dataset to the fixed image size; and
training a machine learning model to output labels for each image of the second dataset, the labels indicating pixels of the image that correspond to unobstructed floorspace and to obstructed floorspace.

9. The computer-implemented method of claim 8, wherein training the machine learning model is by supervised learning.

10. The computer-implemented method of claim 8, wherein the first dataset of labeled images includes images and corresponding ground truth labels, and wherein the images in the first dataset are used as training images and feedback is provided to the machine learning model based on comparison of the output labels for each training image generated by the machine learning model with ground truth labels in the first dataset.

11. The computer-implemented method of claim 8, wherein the machine learning model includes a neural network and training the machine learning model includes adjusting a weight of one or more nodes of the neural network.

12. The computer-implemented method of claim 8, wherein the machine learning model includes:
an encoder that is a pretrained model that generates features based on an input image; and
a decoder that takes the generated features as input and generates the labels for the image as output.

13. The computer-implemented method of claim 12, wherein the encoder and the decoder each include a plurality of layers, and wherein features output by each layer in a subset of the plurality of layers of the encoder is provided as input to a corresponding layer of the decoder.

14. The computer-implemented method of claim 13, wherein:
the plurality of layers of the decoder are arranged in a sequence;
the output of each layer of the decoder is upsampled and concatenated with the features output by a corresponding layer of the encoder and provided as input to a next layer in the sequence; and,
the output of the final layer of the decoder is a pixel classification for each pixel of the image that indicates whether the pixel corresponds to the unobstructed floorspace or the obstructed floorspace.

15. The computer-implemented method of claim 14, wherein each layer of the decoder performs a deconvolution operation, a batch normalization operation, and a rectified linear unit (ReLU) activation.

16. The computer-implemented method of claim 13, wherein the encoder is a pretrained MobileNetV2 model and wherein the subset of layers includes layers 1, 3, 6, 13, and 16.

17. An autonomous mobile robot comprising:
a camera;
a navigation system that includes an actuator; and,
a processor coupled to the camera and operable to control the navigation system by performing operations comprising:
receiving, from the camera, at least one image of a physical environment that includes a floorspace;
compressing, by the processor, the at least one image to a fixed image size to obtain an encoded image;
providing the encoded image to a trained machine learning model, the trained machine learning model configured to return a pixel classification for each pixel of the encoded image that indicates whether the pixel corresponds to unobstructed floorspace or obstructed floorspace;
determining at least a portion of a navigation route based on the pixel classification; and
directing the autonomous mobile robot to traverse the portion of the navigation route.

18. The autonomous mobile robot of claim 17, wherein compressing the at least one image comprises:
applying a filter to the at least one image to reduce image noise and obtain a filtered image; and
reducing an initial size of the filtered image to the fixed image size.

19. The autonomous mobile robot of claim 17, wherein the trained machine learning model is a trained neural network.

20. The autonomous mobile robot of claim 17, wherein the compressing the at least one image is performed by a trained neural network configured to filter noise and to reduce size of the at least one image.
